(19) United States
(12) Patent Application Publication
(10) Pub. No.: US 2014/0231660 A1
(43) Pub. Date: Aug. 21, 2014

(54) Method and device for measuring the concentration of extinguishing agent in a fire zone

(71) Applicant: Airbus Operations (SAS), Toulouse (FR)

(72) Inventors: Christian Fabre, Tournefeuille (FR); Alain Bignolais, Leguevin (FR)

(21) Appl. No.: 14/159,738

(22) Filed: Jan. 21, 2014

(30) Foreign Application Priority Data
Jan. 24, 2013 (FR) 1350632

(51) Int. Cl. G01N 21/85

(52) U.S. Cl. CPC G01N 21/85; G01N 2021/8578
USPC 250/373

(57) ABSTRACT

A device for measuring, on an aircraft, the extinguishing agent concentration of a gaseous mixture. The device includes an ultraviolet radiation detector for generating an output signal that is a function of the concentration of the agent in the gaseous mixture and an electronic circuit for determining the concentration as a function of said output signal. The device includes a unit for sampling the gaseous mixture in at least one fire zone of said aircraft, and a measurement chamber passed through by the gaseous mixture and comprising a tranquilizing chamber, the detector being arranged in such a way as to measure the concentration of the agent in the gaseous mixture passing through the tranquilizing chamber.

### CROSS-REFERENCES TO RELATED APPLICATIONS

This application claims the benefit of the French patent application No. 1350632 filed on Jan. 24, 2013, the entire disclosures of which are incorporated herein by way of reference.

### BACKGROUND OF THE INVENTION

The present invention relates to a method and a device for measuring the concentration of an extinguishing agent in one or more zones of an aircraft in which a fire is likely to arise, hereinbelow designated fire zones, notably in one or more fire zones of an aircraft engine.

Aircraft, and in particular their engine(s), are equipped with a system for diffusing an extinguishing agent in one or more fire zones where a fire might arise. To this end, tanks containing the extinguishing agent are connected by pipelines to these fire zones. In the case of the engines, these tanks are generally arranged in the pylon supporting the engine.

The extinguishing agent currently used on aircraft is HALON 1301™ (registered trademark). To be certified by the civil aviation regulatory authorities, an aircraft has to undergo tests proving that, should the engine extinguishing system be triggered, the concentration by volume of HALON 1301™ in each of the fire zones of the engine is at least equal to 6% by volume for at least 0.5 seconds. The tests take place on the ground, with the engine operating.

HALON 1301™ is considered to have undesirable effects on the environment. It has consequently been prohibited from use by international authorities since 1994, but with exemptions in certain areas of business, including aeronautics. However, these exemptions are likely to end and the replacement, for aeronautical applications, of the HALON 1301™ by another extinguishing agent guaranteeing the same performance levels has to be considered. It appears that another product, NOVEC 1230 (registered trademark), also exhibits excellent qualities as extinguishing agent.

However, the test means employed to measure the concentration of HALON 1301™ in aircraft, and in particular their engines, cannot be used as such with NOVEC 1230™ (registered trademark). In practice, these test means are complex appliances which require a calibration that is very precise and difficult to perform. It is also found that the accuracy provided by these existing means is lesser in the case where the extinguishing agent whose concentration is measured is NOVEC 1230™. Finally, the existing test means are costly appliances that are difficult to transport and very few in number. The invention therefore aims to provide a method and a device for measuring the extinguishing agent concentration in a fire zone of an aircraft which makes it possible to overcome the drawbacks exhibited by the test means designed for HALON 1301™.

### SUMMARY OF THE INVENTION

The invention also aims to provide such a measurement device which is inexpensive, not bulky and simple to use.

Another aim of the invention is to provide such a measurement device which makes it possible to measure, with the required accuracy and over the required duration, the concentration of NOVEC 1230™ in one or more fire zones of an aircraft, in particular its engines.

To this end, the subject of the invention is a device for measuring, on an aircraft, the extinguishing agent concentration of a gaseous mixture, comprising an ultraviolet radiation detector for generating an output signal that is a function of the concentration of said agent in said gaseous mixture and an electronic circuit for determining said concentration as a function of said output signal,

characterized in that said device comprises:

means for sampling said gaseous mixture in at least one fire zone of said aircraft, and

a measurement chamber passed through by said gaseous mixture and comprising a tranquilizing chamber, said detector being arranged in such a way as to measure the concentration of said agent in said gaseous mixture passing through said tranquilizing chamber.

The measurement of the concentration of a gas in a mixture by UV spectroscopy is used in laboratories, that is to say in an environment where the appliances used are extremely clean, as are also the gaseous samples analyzed.

It so happens that the measurement device based on ultraviolet radiation according to the invention makes it possible to measure, in situ with the required accuracy, the concentration of extinguishing agent in an unfavorable environment which is the one encountered in an aircraft, in particular an aircraft engine that is operating: variable temperature, variable degree of humidity, presence of dust, of oil and/or kerosene vapors, of fumes likely to be produced by craft moving around in proximity to the aircraft being tested, of traces of kerosene, of skydrol (hydraulic fluid), and so on.

Furthermore, despite its simplicity, its compactness and its moderate cost, the measurement device according to the invention makes it possible to obtain, with NOVEC 1230™, an accuracy of the measurement of concentration of this agent which is better than that provided by the test means of the prior art dedicated to measuring HALON 1301™.

According to one possible feature of the invention, said ultraviolet radiation detector comprises an emitter of ultraviolet radiation in the band of wavelengths between 280 nm and 320 nm, and preferably between 295 nm and 305 nm corresponding to the band of absorption wavelengths of NOVEC 1230™.

According to another possible feature of the invention, the ultraviolet radiation detector comprises an emitting diode and a photodiode arranged on either side of said chamber. The detector according to the invention is thus particularly simple to design and produce.

According to another possible feature of the invention, said photodiode is of the photovoltaic operation type. This mode of operation is the one which provides the best sensitivity of the photodiode in the measurement context considered.

According to another possible feature of the invention, the diode is of hemispheric type. This type of diode is also the one which happens to give the best sensitivity in the measurement context considered.

According to another feature of the invention, said chamber has a longitudinal axis of flow of said gaseous mixture and said diode and photodiode are aligned in a direction substantially at right angles to said axis. The positioning of said diode and photodiode transversally to the chamber is particularly simple to implement.

According to another possible feature of the invention, said measurement chamber comprises an input cone and an output cone, said tranquilizing chamber being contained between said input and output cones. This arrangement of the measurement chamber makes it possible to obtain a good uniformity of the gaseous mixture being measured and to counteract the dard effect, that is to say the difference in speed between the center and the periphery of the stream of gaseous mixture flowing in the chamber.

According to another possible feature of the invention, said detector is arranged roughly at three quarters of the length of said tranquilizing chamber measured from said input cone. It is at around this point that the best uniformity of the gaseous mixture is obtained.

According to another possible feature of the invention, the measurement device comprises a plurality of measurement units for measuring the extinguishing agent concentration in different distinct fire zones and a unit for processing the data supplied by said measurement units. The measurement device can therefore be dimensioned to perform simultaneous concentration measurements in any number of fire zones of an aircraft, in particular of an engine thereof.

According to another possible feature of the invention, said extinguishing agent is NOVEC 1230™. The measurement device according to the invention makes it possible to measure the concentration of NOVEC 1230™ prescribed by the aeronautical authorities, which is 6.1% by volume for at least 0.5 seconds.

Another subject of the invention is a method for measuring the concentration of an extinguishing agent by means of an ultraviolet radiation detector, comprising the following steps:

continuous sampling of a gaseous mixture in a fire zone of an aircraft,

conducting of said sampled gaseous mixture into a tranquilizing chamber, and

measurement in real time, in said tranquilizing chamber, of the concentration of extinguishing agent in said continuous sampling of gaseous mixture by means of said ultraviolet radiation detector.

The measurement method based on ultraviolet radiation according to the invention makes it possible to measure, in situ with the required accuracy, the concentration of extinguishing agent in an extremely unfavorable environment, such as that of an aircraft, in particular an aircraft engine: variable temperature, variable degree of humidity, presence of dust, of oil and/or kerosene vapors, of fumes likely to be produced by craft moving around in proximity to the aircraft being tested, of traces of kerosene, of skydrol (hydraulic fluid), and so on.

According to another possible feature of the invention, said ultraviolet radiation detector has a radiation situated in at least one of the bands comprising the band from 280 nm to 320 nm and the band from 295 nm to 305 nm. The best measurement results in terms of sensitivity and accuracy are obtained in these bands, particularly in the narrowest band.

According to yet another possible feature of the invention, said extinguishing agent is NOVEC 1230™ for which the method makes it possible to measure the concentration with a good accuracy.

### BRIEF DESCRIPTION OF THE DRAWINGS

Other features and advantages of the invention will emerge from the following description of an embodiment, given purely as an example and illustrated by the attached drawings in which:

FIG. 1 is a simplified schematic view of a device according to the invention for measuring the concentration of an extinguishing agent in a gaseous mixture;

FIG. 2 is a view in longitudinal cross section of a measurement chamber used in the measurement device of FIG. 1; and

FIG. 3 is a diagram of a device according to the invention for measuring the concentration of an extinguishing agent in different zones of an engine.

### DETAILED DESCRIPTION OF THE PREFERRED EMBODIMENTS

The measurement device and method which will be described hereinbelow are particularly suited to measuring, in situ, the concentration of the extinguishing agent NOVEC 1230™ (registered trademark) in a gaseous mixture sampled in a fire zone of an aircraft, particularly in an aircraft engine in operation as described hereinbelow. However, this measurement device and method are not limited to measuring NOVEC 1230™ and can be used to measure the concentration of other extinguishing agents by, if necessary, adapting the wavelength of the emitting diode.

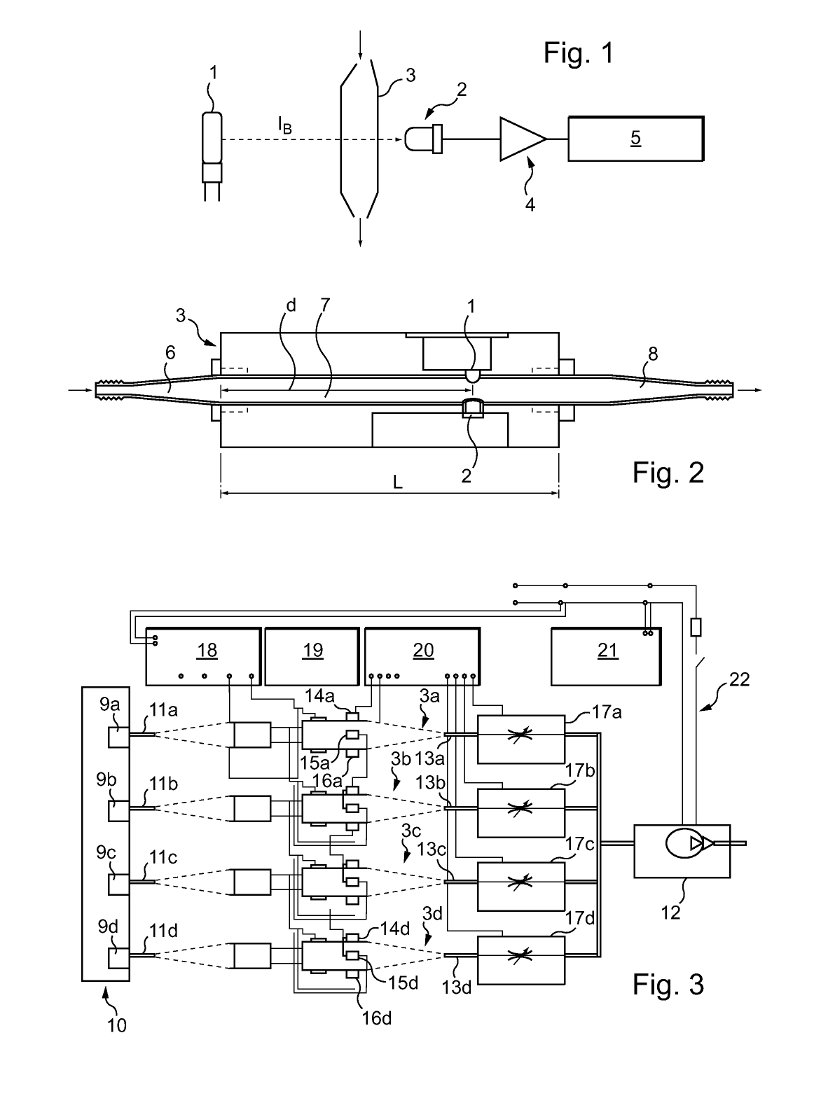

The measurement device comprises a unit for sampling gas in the fire zone of the engine to be tested and a measurement unit proper illustrated in FIG. 1 and comprising a diode 1 emitting an ultraviolet radiation IB and a photodiode 2 sensitive to said ultraviolet radiation, which are arranged on either side of a measurement chamber 3.

The photodiode 2 is connected to an amplifier 4 whose output is connected to an electronic circuit 5 for analyzing an output signal from the photodiode 2 amplified by the amplifier 4.

The emitting diode 1 is a hemispheric diode emitting an ultraviolet radiation in a band between 280 nm and 320 nm, and preferably between 295 and 305 nm. It is, for example, the diode of model UVTOP295-T039 from the company Roithner Lasertechnik.

The photodiode 2 is preferably used in photovoltaic mode, that is to say without polarization between the cathode and the anode. It is, for example, the model TW30DY Ti02 253-361 nm T039 from the company Roithner Lasertechnik.

The diode 1 and the photodiode 2 are adapted to operate at 50 Hz, which constitutes an acceptable frequency for continuously measuring the concentration of NOVEC 1230™ in the gases which pass through the measurement chamber 3. This measurement is based on the Beer-Lambert law:

$$A = log ( \frac{io}{i} ) = ∈ 1 C$$

in which:

A is the absorbance of NOVEC 1230™,

io is the light intensity emitted by the diode 1,

i is the light intensity received by the photodiode 2,

ε is the molar absorptivity of NOVEC 1230™, which depends on the wavelength,

1 is the distance between the emitting diode 1 and the photodiode 2,

C is the concentration of NOVEC 1230™, the unit depending on the coefficient ε.

There is a similar relationship between absorbance and voltage:

$$A = log ( \frac{Uo}{U} ) = ∈ 1 c$$

in which:

U is the output voltage of the photodiode 2 in the presence of transmitted light intensity io,

Uo is the output voltage of the photodiode 2 when it receives the light intensity i.

The diode 1 and the photodiode 2 are preferably placed at a distance of approximately 40 mm from one another, on either side of the measurement chamber 3.

The measurement chamber 3 comprises an input cone or divergent 6 of tapered form, a cylindrical tranquilizing chamber 7 extending in the extension of the input divergent 6, and an output cone or convergent 8 of tapered form extending in the extension of the tranquilizing chamber 7.

As FIG. 3 also shows, the measurement unit is complemented by a sampling unit comprising a pipeline 11 connecting the input divergent 6 to a fire zone 9 of the engine to be tested 10, a pump 12 for sucking the gases to be analyzed and a pipeline 13 connecting the output convergent 8 to the pump 12.

The cylindrical tranquilizing chamber 7 preferably has a diameter of the order of 40 to 50 mm. The diode 2 and the photodiode 3 are mounted so as to be diametrically opposite on either side of the chamber 7, emerging therein in such a way as to be spaced apart by approximately 40 mm from one another.

Given that the measurement of the concentration of NOVEC 1230™ in the tranquilizing chamber 7 is sensitive to pressure, to humidity and to temperature, pressure 14, humidity 15 and temperature 16 sensors are mounted on the chamber 7 in order to make it possible to make the required corrections to the measurement. Preferably, the measurement device is temperature-conditioned (at approximately 30° C.) to have, at the component level, identical test conditions whatever the ambient temperature outside the system.

The method for measuring the concentration of extinguishing agent NOVEC 1230™ in fire zones of an engine for the certification of the aircraft which is equipped therewith proceeds as follows.

The aircraft is immobilized on the ground with the engine 10 operating.

The procedure for extinguishing a fire on an engine is applied and the extinguishing agent stored in tanks is brought into the fire zones of the engine by appropriate pipelines. Gas samples are taken continuously from said fire zones to measure the concentration of extinguishing agent.

For a given fire zone, the sampled gas is brought into the tranquilizing chamber 7 via suitable pipelines 11 or capillaries and the input divergent 6. The configuration of the measurement chamber 3, with its input divergent 6, its tranquilizing chamber 7 and its output convergent 8, is designed to minimize the dard effect.

The dard effect reflects the fact that, in a volume of gas flowing in a tube, a non-uniformity of speeds exists between the center of the tube and its periphery, with a greater flow velocity at the center of the tube. Such a phenomenon affects the uniformity of the gas in the flowing volume, and therefore the accuracy of the measurement of the concentration of the extinguishing agent in this volume of gas.

It also happens that, with the configuration of the measurement chamber 3 described, the dard effect is minimized, and the flowing gaseous mixture is more uniform at a distance “d” from the upstream end of the tranquilizing chamber 7 (that is to say, the end where it is connected to the divergent 6) representing approximately three quarters (¾) of its length “L” between the divergent 6 and the convergent 8. It is therefore at this distance “d” from the upstream end of the tranquilizing chamber 7 that the diode 1 and the photodiode 2 are placed.

The input divergent 6 and the output convergent 8 can also be optimized to limit the turbulences in the flow. The angle of the cone of the divergent 6 and of the convergent 8 is between 5° and 10°, and preferably 7°.

The extinguishing agent concentration curve is established continuously as a function of time in the fire zone considered over the duration of the measurement considered.

The extinguishing system of the aircraft will be certified if the concentration of extinguishing agent reaches a minimum value over a minimum duration, namely 6.1% for at least 0.5 seconds in the case of NOVEC 1230™.

In order to be able to carry out this certification test, the device for measuring extinguishing agent concentration can have as many units for sampling the gaseous mixture and concentration measurement units as there are fire zones to be tested.

Such a measurement device equipped with four measurement units for testing four fire zones 9a, 9b, 9c and 9d of an engine 10 is represented in FIG. 3.

Each measurement unit comprises the various elements described in relation to FIGS. 1 and 2, which are assigned letters a, b, c or d in FIG. 3 according to the fire zone to which the measurement device is connected.

The output pipelines 13a, 13b, 13c and 13d of the measurement devices are connected to the pump 12, which is common to all four sampling units, by variable throttle regulators 17a, 17b, 17c and 17d respectively which makes it possible to set the flow rate in the corresponding measurement chambers 3a, 3b, 3c and 3d.

The four measurement devices denoted a, b, c and d have in common:

an electronic electrical power supply board 18 for the different components,

an electronic amplification board 19,

an electronic data acquisition board 20, and

a unit 21 for processing the signals collected, which can consist, for example, of a PC equipped with appropriate software.

A circuit 22 makes it possible to electrically power the pump 12, the electronic boards 18, 19 and 20, and the processing unit 21. For the clarity of the drawing, the electrical connections between the electronic boards 18, 19 and 20 and the measurement units are not represented.

The measurement device and method described above are suited to the in situ measurement of the concentration of extinguishing agent in one or more aircraft fire zones, for example the fire zones of the engines of these aircraft (such as jet engines or turboprop engines), but also in other fire zones of the aircraft, such as cargo or other zones.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-14. (canceled)

15. A device for measuring, on an aircraft, the extinguishing agent concentration of a gaseous mixture, comprising:
an ultraviolet radiation detector which generates an output signal that is a function of the concentration of said agent in said gaseous mixture and an electronic circuit for determining said concentration as a function of said output signal,
a unit for sampling said gaseous mixture in at least one fire zone of said aircraft, and
a measurement chamber passed through by said gaseous mixture and comprising a tranquilizing chamber, said detector being arranged in such a way as to measure the concentration of said agent in said gaseous mixture passing through said tranquilizing chamber.

16. The device as claimed in claim 15, wherein said ultraviolet radiation detector comprises an emitter of ultraviolet radiation in the band of wavelengths between 280 nm and 320 nm.

17. The device as claimed in claim 16, wherein the wavelength of said ultraviolet radiation is between 295 nm and 305 nm.

18. The device as claimed in claim 15, wherein the ultraviolet radiation detector comprises an emitting diode and a photodiode arranged on either side of said chamber.

19. The device as claimed in claim 18, wherein said photodiode is of the photovoltaic operation type.

20. The device as claimed in claim 17, wherein said emitting diode is of hemispheric type.

21. The device as claimed in claim 17, wherein said chamber has a longitudinal axis of flow of said gaseous mixture and said emitting diode and photodiode are aligned in a direction substantially at right angles to said axis.

22. The device as claimed in claim 15, wherein said measurement chamber comprises an input cone, an output cone, said tranquilizing chamber being contained between said input and output cones.

23. The device as claimed in claim 22, wherein said detector is arranged roughly at three quarters of the length of said tranquilizing chamber measured from said input cone.

24. The device as claimed in claim 15, further comprising a plurality of measurement units for measuring the extinguishing agent concentration in each of a plurality of distinct fire zones and a unit for processing the data supplied by said measurement units.

25. The device as claimed in claim 15, wherein said extinguishing agent is NOVEC 1230™.

26. A method for measuring, on an aircraft, the concentration of an extinguishing agent by means of an ultraviolet radiation detector, comprising the steps:
continuously sampling a gaseous mixture in a fire zone of an aircraft,
conducting said sampled gaseous mixture into a tranquilizing chamber, and
measuring in real time, in said tranquilizing chamber, the concentration of extinguishing agent in said continuous sampling of gaseous mixture by means of said ultraviolet radiation detector.

27. The method as claimed in claim 26, wherein said ultraviolet radiation detector has a radiation situated in at least one of the bands comprising the band from 280 nm to 320 nm and the band from 295 nm to 305 nm.

28. The method as claimed in claim 26, wherein said extinguishing agent is NOVEC 1230™.
